(19) United States
(12) Patent Application Publication
(10) Pub. No.: US 2010/0100692 A1
(43) Pub. Date: Apr. 22, 2010

(54) Exploiting Register High-Words

(75) Inventors: Marcel Mitran, Markham (CA); Timothy J. Slegel, Staatsburg, NY (US); Alexander Vasileveskiy, Brampton (CA)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/255,212

(22) Filed: Oct. 21, 2008

(51) Int. Cl. G06F 12/00

(52) U.S. Cl. 711/154; 711/E12.001

(57) ABSTRACT

A method of utilizing registers in a processor device is provided. The method includes: determining a first operand based on an operand notation indicating a subset of high-order bits of a first register, the first register having a total of sixty-four bits; determining a second operand based on an operand notation indicating at least one of a subset of high-order bits of a second register and a subset of low-order bits of the second register, the second register having a total of sixty-four bits; performing an operation based on the first operand and the second operand; and updating at least one of the first register and the second register based on a result of the operation, and wherein the high-order bits include bits that are greater than thirty-two, and wherein the low-order bits include bits that are less than or equal to thirty-two.

### BACKGROUND

The present disclosure relates to methods, systems, and computer program products for using high-order words of 64-bit registers.

Processors that support 64-bit wide registers include an Instruction Set Architecture (ISA) that can be divided into two functional subsets: the legacy 32-bit ISA that exploits the lower half of the 64-bit registers and a newer 64-bit ISA that exploits the full width of the registers. Typical applications will use a mix of the 32-bit and 64-bit ISAs. For example, the Java specification requires that array indices be represented as signed 32-bit integers—hence all representations and manipulations of such indices would require 32-bit ISA support uniquely independently of whether a 32-bit or 64-bit addressable Java Development Kit is implemented.

In many cases, when a compiler assigns a register to represent a 32-bit expression, the upper part of that register is needlessly assumed killed. However, the 32-bit data path has no effect on the upper word of the 64-bit registers. It would be desirable for compilers to make use of these upper words as an extra set of 32-bit registers. However, poor support by current ISAs for accessing and uniquely operating on these high words makes it in-practical to use these high words without performing extraneous work to either spill or rotate the registers appropriately.

### SUMMARY

Accordingly, in one embodiment, a method of utilizing registers in a processor device is provided. The method includes: determining a first operand based on an operand notation indicating a subset of high-order bits of a first register, the first register having a total of sixty-four bits; determining a second operand based on an operand notation indicating at least one of a subset of high-order bits of a second register and a subset of low-order bits of the second register, the second register having a total of sixty-four bits; performing an operation based on the first operand and the second operand; and updating at least one of the first register and the second register based on a result of the operation, and wherein the high-order bits include bits that are greater than thirty-two, and wherein the low-order bits include bits that are less than or equal to thirty-two.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The drawings described herein are for illustration purposes only and are not intended to limit the scope of the present disclosure in any way. It should be understood that throughout the drawings, corresponding reference numerals indicate like or corresponding parts and features.

FIG. 1 is a functional block diagram illustrating a computing system that includes a high-order word processing system in accordance with an exemplary embodiment.

FIG. 2 is a functional block diagram illustrating 64-bit registers of a register file of the computing system of FIG. 1 in accordance with an exemplary embodiment.

FIG. 3 is an instruction set of the high-order word processing system in accordance with an exemplary embodiment.

FIG. 4 is an exemplary dataflow for an addition operation of the high-order word processing system in accordance with an exemplary embodiment.

### DETAILED DESCRIPTION

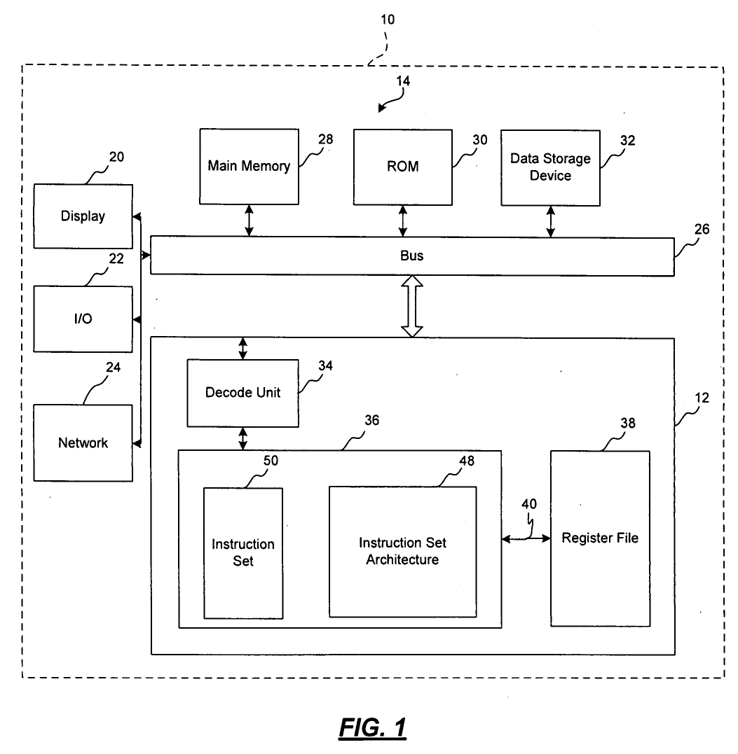

Turning now to the drawings in greater detail, it will be seen that in FIG. 1 an exemplary computing system 10 includes, but is not limited to, a processor 12, one or more memory devices 14, a display device 20, an input/output device 22, a network device 24, and a communication device 26. The processor 12 processes information of the computer system 10. The communication device 26 can include, for example, a bus. The communication device 26 communicates data between the processor 12 and the one or more memory devices 14, the display device 20, the input/output device 22, and the network device 24.

The one or memory devices 14 can include, for example, a random access memory (RAM) or other dynamic storage device (hereinafter referred to as main memory 28), read only memory (ROM) 30, and other static data storage devices 32. The main memory 28, the ROM 30, and the data storage devices 32 store information and/or instructions that are executed by the processor 12.

As shown in FIG. 1, the processor 12 includes, but is not limited to, a decoder 34, an execution unit 36, a register file 38, and an internal bus 40. As can be appreciated, the processor 12 can include additional elements not applicable to the present disclosure. For ease of the discussion, those elements have been left out.

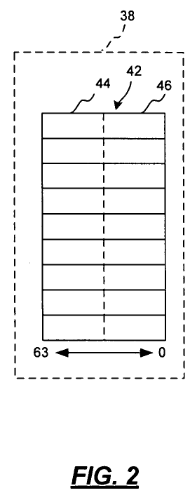

The decoder 34 decodes instructions received by the processor 12 from the communication device 26. The execution unit 36 receives the decoded instructions and performs the corresponding operations. To perform the operations, the execution unit 36 communicates data to and from the register file 38 via the internal bus 40. As shown in FIG. 2, the register file 38 includes a plurality of 64-bit registers 42. The 64-bit registers 42 can be divided into a high-order word 44 and a low-order word 46, where the high-order word 44 consists of bits 32-63 and the low-order word 46 consists of the bits 0-31.

With reference back to FIG. 1, in addition to executing instructions typically implemented in general purpose processors, the execution unit 36 includes an high-order word instruction set architecture (ISA) 48 that executes instructions of a high-order word instruction set 50 as disclosed herein. The high-order word instruction set 50 includes instructions for supporting operations using the upper word 44 of the 64-bit registers 42 as independent 32-bit registers. The high-order word ISA 48 includes hardware for executing the instructions of the instruction set 50. In one example, the high-order word instruction set 50 includes, but is not limited to, add instructions, branch instructions, compare instructions, load instructions, rotate instructions, store instructions, and subtract instructions that make use of operands from the high-order word 44 (FIG. 2), and a mix operands from of the high-order word 44 (FIG. 2) and the low-order word 46 (FIG. 2).

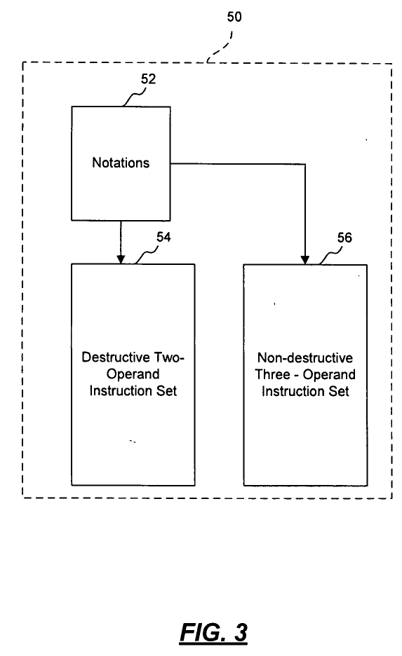

Turning now to FIG. 3, the high-word instruction set 50 is shown in more detail in accordance with an exemplary embodiment. The high-word instruction set 50 includes one or more notations 52 and instruction sets 54, 56. As can be appreciated, the instruction sets 54, 56 can be combined and/or further partitioned to similarly perform operations on the high-order words 44 (FIG. 2). In this example, the instruction sets can include, a destructive two-operand instructions set 54, and a non-destruction three-operand instructions set 56.

The operand notations 52 provide definitions for an order, a location, an order of the bits, and/or a residency of the various operands. In one example, the notations indicate whether the operand is a first operand, a second operand, a source operand, a target operand, a memory resident operand, a register resident operand, a low-order bits operand, or a high-order bit operand. Table 1 indicates exemplary notations the various operands.

TABLE 1

| Order | Operand1 | Operand2 |
|---|---|---|
| Location | Operand_source | Operand_source |
| | Operand_targert | Operand_target |
| | Operand1_source | Operand2_source |
| | Operand1_target | Operand2_target |
| Order Bits | Operand1_source_H | Operand2_source_H |
| | Operand1_target_H | Operand2_target_H |
| | Operand1_source_L | Operand2_Source_L |
| | Operand1_target_L | Operand2_Target_L |
| Residency | Reg(Operand1_source_H) | Reg(Operand2_source_H) |
| | Reg(Operand1_target_H) | Reg(Operand2_target_H) |
| | Reg(Operand1_source_L) | Reg(Operand2_source_L) |
| | Reg(Operand1_target_L) | Reg(Operand2_target_L) |
| | Mem(Operand1_source_H) | Mem(Operand2_source_H) |
| | Mem(Operand1_target_H) | Mem(Operand2_target_H) |
| | Mem(Operand1_source_L) | Mem(Operand2_source_L) |
| | Mem(Operand1_target_L) | Mem(Operand2_target_L) |

For example, Operand1_source, indicates that the operand is the first operand and is a source operand. For example, Reg(Operand2_target), indicates that the second operand, which is a target, resides in a register. Finally, an L or H qualifier is used to indicate where there lower or higher 32-bit word is active in the operation. For example, Mem(Operand1_source_H), indicates that the first operand is in the high 32-bits of a register that represents the location in memory where the source resides.

The destructive two-operand instruction set 54 is architected such that a first operand is applied to a second operand in some binary operation (e.g., arithmetic, bit-wise logic, logical/signed ordering, etc). If the result of the operation generates a new expression, the second operand is updated with the expression. The relationship can be shown as:

Operand target<=Operand target operation Operand source.

The totality of possible operations can be expressed as some instance of the following set of functions:

Reg/Mem(Operand_target_L/H)<=Reg/Mem(Operand target_L/H) operation Reg/Mem(Operand_source_L/H).

In one example, the instructions provide for the following memory scenarios including, but not limited to,: a register-to-register high word source, a register-to-register high word target, a memory-to-register high word source, a memory-to-register high word target a register-to-memory high word source, and a register-to-memory high word target.

In the case of the register-to-register high word source scenario, the instructions provide that the source operand is obtained from the high-order word 44 (FIG. 2) of the source register and is applied to the 32-bit low-order word 46 (FIG. 2) of the target register. If the result of the operation generates a target expression, the instruction stores this expression to the low-order word 46 (FIG. 2) of the target register, leaving the high-order word 44 (FIG. 2) unmodified. The relation is shown as:

Reg(Operand_target_L)<=Reg(Operand_target_L) operation Reg(Operand_source_H).

In the case of the register-to-register high word target, the instructions provide that the source operand is obtained from the 32-bit low-order word 46 (FIG. 2) of the source register and is applied to the 32-bit high-order word 44 (FIG. 2) of the target register. If the result of the operation generates a target expression, the instruction stores this expression to the high-order word 44 (FIG. 2) of the target register, leaving the low word unmodified. The relation is shown as:

Reg(Operand_target_H)<=Reg(Operand_target_H) operation Reg(Operand_source_L).

In the case of the memory-to-register high word source, the instructions provide that the memory location for the source operand is computed using the high-order word 44 (FIG. 2) of the register that defines the memory reference. The low-order word 46 (FIG. 2) of the second register is used as the second operand of the operation. If the result is stored to the target register, the instruction modifies the low-order word 46 (FIG. 2) of the result, leaving the high-order word 44 (FIG. 2) unchanged. The relation is shown as:

Reg(Operand_target_L)<=Reg(Operand_target_L) operation Mem(Operand_source_H).

In the case of the memory-to-register high word target, the instructions provide that the memory location for the source operand is computed using the low-order word 46 (FIG. 2) of the register that defines the memory reference. The high-order word 44 (FIG. 2) of the second register is used as the second operand of the operation. If the result is stored to the target register, the instruction modifies the high-order word 44 (FIG.2) of the result, leaving the low-order word 46 (FIG. 2) unchanged. The relation is shown as:

### Reg(Operand_target_H)<=Reg(Operand_target_H)operation Mem(Operand_source_L).

In the case of the register-to-memory high word source, the instructions provide that the source operand is obtained from the high-order word 44 (FIG. 2) of the source register. The instruction computes the memory location for the target operand using the low-order word 46 (FIG. 2) of the register that defines its memory location. The relation is shown as:

Mem(Operand_target_L)<=Mem(Operand_target_L) operation Reg(Operand_source_H).

In the case of the register-to-memory high word target, the instructions provide that the source operand is obtained from the low-order word 46 (FIG. 2) of the source register. The instruction computes the memory location for the target operand using the high-word of the register that defines its memory location. The relation is shown as:

Mem(Operand_target_H)<=Mem(Operand_target_H) operation Reg(Operand_source_L).

The non-destructive three-operand instruction set 56 is architected such that the first operand is applied to the second operand in some binary operation (e.g., arithmetic, bit-wise logic, logical/signed ordering, etc) and a third operand is updated with the result of the operation. The relationship can be shown as:

Reg/Mem(Operand_target_L/H)<=Reg/Mem(Operand_source2_L/H) operation Reg/Mem(Operand_source1_L/H)

As can be appreciated, the instruction set 56 similarly provides for the memory scenarios including, but not limited to: a register-to-register high word source 1, a register-to-register high word source 2, a memory-to-register high word source 1, a memory-to-register high word service 2, a register-to-memory high word source 1, and a register-to-memory high word source 2.

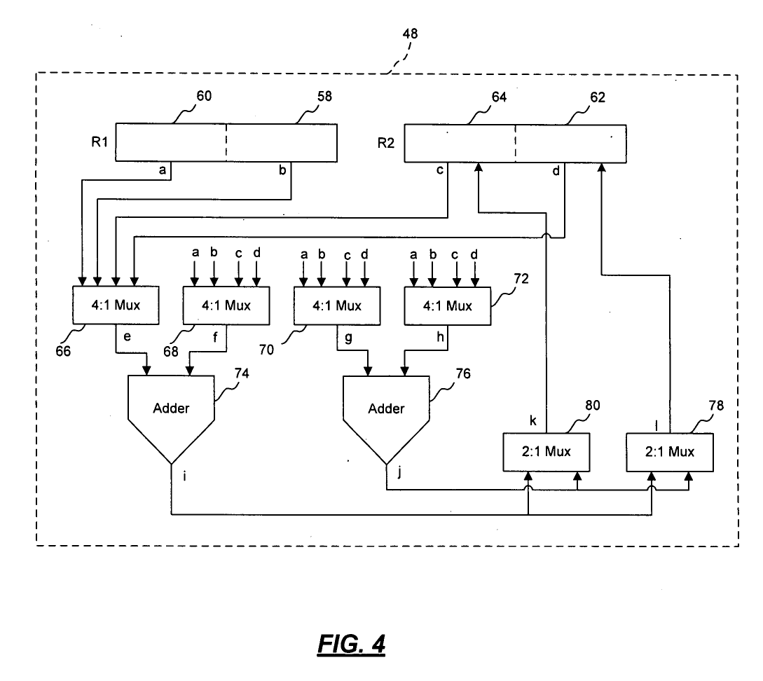

Referring now to FIG. 4, an illustration of an exemplary data path for a high-order word ISA 48 that executes the binary operation of addition on the high-order words 44 (FIG. 2) according to the high-order word instruction set 50 (FIG. 3). As can be appreciated, the high-order word ISA 48 includes similar hardware and data paths for the other binary operations.

As shown, a first register R1 includes 64 bits divided into a low-order word 58 and a high-order word 60. Similarly, a second register R2 includes 64 bits that are dived into a low-order word 62 and the high-order word 64. A series of 4:1 multiplexors 66-72 receive data signals a-d containing the values stored in each of the high-order words 60,64 and the low-order words 58,62. Depending on the value of a select (as determined by the instruction), the multiplexors 66-72 generate output signals e-h. The output signals e-h of the multiplexors 66-68 are received by a first adder 74. The output signals g-n of the multiplexors 70-72 are received by a second adder 76. The adders 74, 76 each perform a binary addition operation on the input values and generate an output signal i, j respectively. A first 2:1 multiplexor 78 associated with the low-order word 62 of the second register R2 receives the output signal i, j from the adders 70, 76 respectively. A second 2:1 multiplexor 80 associated with the high-order word 64 of the second register R2 similarly receives the outputs signals i, j from the adders 70, 76 respectively. Depending on the value of a select as determined by the instruction, the multiplexors 78, 80 generate output signals i, k to the low-order word 62 and the high-order word 64 respectively.

As can be appreciated, the capabilities of the present disclosure can be implemented in software, firmware, hardware or some combination thereof.

As one example, one or more aspects of the present disclosure can be included in an article of manufacture (e.g., one or more computer program products) having, for instance, computer usable media. The media has embodied therein, for instance, computer readable program code means for providing and facilitating the capabilities of the present disclosure. The article of manufacture can be included as a part of a computer system or provided separately.

Additionally, at least one program storage device readable by a machine, tangibly embodying at least one program of instructions executable by the machine to perform the capabilities of the present disclosure can be provided.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this disclosure, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages.

While a preferred embodiment has been described, it will be understood that those skilled in the art, both now and in the future, may make various improvements and enhancements which fall within the scope of the claims which follow. These claims should be construed to maintain the proper protection for the disclosure first described.

The terminology used herein is for the purpose of describing particular embodiments only and is not intended to be limiting of the invention. As used herein, the singular forms “a”, “an” and “the” are intended to include the plural forms as well, unless the context clearly indicates otherwise. The corresponding structures, features, materials, acts, and equivalents of all means or step plus function elements in the claims below are intended to include any structure, material, or act for performing the function in combination with other claimed elements as specifically claimed. The disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of utilizing registers in a processor device, the method comprising:
determining a first operand based on an operand notation indicating a subset of high-order bits of a first register, the first register having a total of sixty-four bits;
determining a second operand based on an operand notation indicating at least one of a subset of high-order bits of a second register and a subset of low-order bits of the second register, the second register having a total of sixty-four bits;
performing an operation based on the first operand and the second operand; and
updating at least one of the first register and the second register based on a result of the operation, and
wherein the high-order bits include bits that are greater than thirty-two, and wherein the low-order bits include bits that are less than or equal to thirty-two.

2. The method of claim 1 wherein the updating comprises updating at least one of the high-order bits and the low-order bits of the at least one of the first register and the second register.

3. The method of claim 1, wherein the updating further comprises updating a third register based on the result of the operation, the third register including a total of at least sixty-four bits.

4. The method of claim 3 wherein the third register includes at least one of low-order bits and high-order bits and wherein the updating comprises updating the at least one of the low-order bits and the high-order bits of the third register.

5. The method of claim 1 wherein the operations include at least one of addition, branch, compare, load, store, and subtract.

6. A processor, comprising:
at least two registers that each include a total of sixty-four bits, wherein a first subset of the bits includes the first thirty-two bits, and wherein a second subset of the bits includes the bits greater than the first thirty-two bits; and
an instruction set that includes a plurality of instructions that support operations that are performed on the second subset.

7. The processor of claim 6 wherein the instruction set further includes a plurality of instructions that support operations to be performed on a combination of the first subset and the second subset.

8. The processor of claim 6 wherein the operations include at least one of addition, branch, compare, load, store, and subtract.

9. The processor of claim 6 further comprising an instruction set architecture that supports the operations that are performed on the second subset.

10. The processor of claim 6 wherein the instruction set includes a plurality of operand notations that define at least one of an order, a location, an order of the bits, and a residency of the subsets.

11. The processor of claim 10 wherein the instruction set architecture includes a plurality of multiplexors that select the subset based on an operand notation.

12. A processor, comprising:
at least two registers that each include a total of sixty-four bits, wherein a first subset of the bits includes the first thirty-two bits, and wherein a second subset of the bits includes the bits greater than the first thirty-two bits; and
an instruction set architecture that supports operations that are performed on the second subset.

14. The processor of claim 12 wherein the instruction set further includes a plurality of instructions that support operations to be performed on a combination of the first subset and the second subset.

15. The processor of claim 12 wherein the operations include at least one of addition, branch, compare, load, store, and subtract.
